(19) United States
(12) Patent Application Publication
(10) Pub. No.: US 2008/0226853 A1
(43) Pub. Date: Sep. 18, 2008

(54) Food Casing Having a Transferable Additive Layer

(76) Inventors: Gert BUEKER, Singhofen (DE); Marion Bueker, Singhofen (DE)

Correspondence Address: PROPAT, L.L.C., 425-C SOUTH SHARON AMITY ROAD, CHARLOTTE, NC, 28211-2841, US

(21) Appl. No.: 12/046,515

(22) Filed: Mar. 12, 2008

(30) Foreign Application Priority Data
Mar. 16, 2007 (DE) 10 2007 013 369.5

(51) Int. Cl. A22C 13/00; B05D 3/00

(52) U.S. Cl. 428/34.8; 427/372.2

(57) ABSTRACT

The invention relates to a single-layer or multilayer, flat or tubular food casing having a support based on a water-insoluble thermoplastic polymer, a polymer of animal or plant or chemical origin, or regenerated or precipitated cellulose, an adhesion layer (binder layer) firmly bound to the support and a transferable layer situated thereon. This transferable layer comprises particulate foods having a mean particle size of 60 to 800 μm, if appropriate also food additives such as food dyes and liquid smoke. In addition the invention relates to a method of producing the casing and use thereof as wrapping of meat and sausage products, fish products, cheese, baked goods and confectionery.

### CROSS-REFERENCE TO RELATED APPLICATIONS

This application claims priority to German Patent Application No. 10 2007 013 369.5, filed Mar. 16, 2007 which is hereby incorporated herein by reference in its entirety.

### FIELD OF THE INVENTION

The invention relates to a flat or tubular food casing having a single-layer or multilayer water-insoluble support, an adhesion layer (binder layer) firmly bound to the support and a transferable layer in contact therewith comprised of at least one food and/or at least one food additive. In addition, the invention relates to a method of producing the casing, and to its use.

### BACKGROUND OF THE INVENTION

Tubular food casings, especially artificial sausage casings which contain substances which are transferable to the food or the sausage emulsion, such as food dyes, spices, fruits and also odorants and/or flavorings, are already known. For instance, EP-A 0 986 957 describes a casing having a layer based on polyolefin, polyester, poly(vinylidene chloride) (PVDC), poly(vinyl chloride) (PVC) or polystyrene and also a further layer which is provided for food contact. This inner layer comprises a polysaccharide and/or protein as binder, and, mixed therewith, an aroma substance. This is preferably liquid grilled chicken aroma, honey, lemon oil or orange oil.

The aroma substance can also be a particulate solid, for example finely ground pepper. The mean size of the particles is then generally 0.5 to 50 μm, preferably 1 to 30 μm. The inner layer can in addition contain a crosslinker, for example a compound having at least two carbonyl groups.

The sausage casing according to EP-B 0 802 735 (=U.S. Pat. No. 5,992,345), on the inside, has an adhesion layer solidifying from the liquid state, wherein, as casing material, use is made of a woven cotton fabric having a linen weave. Before solidification, spice particles, in particular peppercorns or ground pepper, are applied thereon. This is preferably achieved by scattering using special devices.

EP-B 0 408 164 describes a matrix material comprised of natural or synthetic fibers which is resistant to water and heat. On this matrix material is a layer of herbs, spices, seafood or milk products in powder or chip form. The food layer and the matrix material are connected by an adhesive layer comprised of an edible, water-soluble, high-molecular-weight material. Examples of the edible, water-soluble, high-molecular-weight material are natural polysaccharides, such as starch, modified starch, dextran, guar gum, xanthan gum. Gum arabic or pullulan, in addition also gelatin and also synthetic materials such as carboxymethylcellulose Na salt or carboxymethylstarch, are also mentioned. Transfer of the food layer to the surface of a product situated in the casing proceeds with the action of moisture.

It is also known to apply spices to foods using gelatin or starch as binder.

All of the known casings having inner layers or inner coatings which contain a transferable additive, and also the application using gelatin or starch, have the disadvantage that either their production industrially is very complex and labor-intensive, that they cannot transfer the additives in sufficient amount, or that they may be taken off with difficulty. Starch-containing casings, in addition, are very susceptible to microbial contamination.

Food casings from regenerated cellulose which can also be reinforced with a fiber paper insert and are then termed cellulose-fiber casings or simply fiber casings, because of their proven good properties such as elasticity and strength, particularly in medium and large calibers, are used in the food sector particularly where high permeability to water vapor and oxygen is desired, for example in the production of uncooked preserved sausage (especially salami). However, it is difficult to transfer a food or a food additive using such casings.

### SUMMARY OF ADVANTAGEOUS EMBODIMENTS

It was therefore an object of the present invention to provide a food casing which does not have said disadvantages.

### DETAILED DESCRIPTION OF ADVANTAGEOUS EMBODIMENTS

The present invention accordingly relates to a food casing having a single-layer or multilayer, water-insoluble support, an adhesion layer firmly bound to the support and a transferable layer in contact therewith comprised of at least one food and/or food additive, in which the adhesion layer contains silicone, silicone rubber or mixtures thereof.

The support is preferably a film, a textile material or a combination thereof based on a water-insoluble, thermoplastic polymer, a polymer of animal or plant origin, or regenerated or precipitated cellulose. The textile material can comprise one or more of said polymers of natural and/or synthetic origin. The term “textile material” is intended to be taken to mean not only woven fabrics, but also loop-drawingly knitted fabrics, loop-formingly knitted fabrics, laid fabrics, nonwovens, spunbonded nonwovens and other flat material comprised of fibers. “Nonwovens” in this case also includes fiber papers and parchment paper. Examples of textile supports are fabrics made of viscose staple or of a viscose staple/polyester blend, and also parchment. The support can also be a film or a combination of textile material and film. Composites comprised of fiber paper and plastic film have proved to be particularly highly suitable. Textile (mixed) fabrics, plastic films and composite materials comprised of plastic/parchment are preferably used.

“Water-insoluble” means that the support is virtually insoluble in cold, hot and boiling water or water vapor, as is customarily used for cooking cooked-meat sausage and scalded-emulsion sausage.

The food casing of the invention is preferably shaped to form a tube, but it can also occur as flat material (in what are termed “sheets”).

The additive comprises preferably pulverulent or fine-grained to coarse-grained foods having a mean particle size of at least 20 μm. “Food” and “food additive”, in this context, are intended to be taken to mean all herbs, spices, cereal grains, nuts and fruits, and also cheese varieties in grated or flaked form, where they are used in the production of sausage, fresh meat, fish and cheese. Included therein are also components for Maillard reactions or amino acids, such as cystein acting as a flavour enhancer. In principle, liquid food (additives), for example liquid smoke, may also be used. Hereinafter, the additives applied to the binder layer will also be termed “additive”.

In contrast thereto, foods which are intended to be enclosed by the casing of the invention are termed “filling” or where confusion is excluded, also “foodstuff”.

The special binders used for the adhesion layer generally have a high adhesive strength. They can be produced from materials of varying viscosity. The binder can proceed from two liquid components which are mixed shortly before use, or from one component to which a crosslinker is added. These components are vulcanized on the matrix to form a solid. The binder receives its adhesive properties after vulcanization. By appropriate choice of the mixing proportions of the components and the amount of catalyst, the adhesive strength can be set as desired.

The additive situated on the binder layer is transferred to the filling situated in the casing particularly rapidly at temperatures up to about 90° C. However, it is also possible to choose the binder in such a manner that it transfers the additives anchored thereon to the enclosed material even at low temperatures. The binder releases the additive to the sausage emulsion under the action of moisture or as a result of a stronger adhesion to the filling than to the binder layer.

As silicones for the binder layer, use is preferably made of pasty, in part transparent, two-component systems, or one-component systems having viscosities of 30 000 to 900 000 mPas. Immediately before coating, the two-component systems (for example an RTV-2 rubber crosslinking at room temperature) are mixed, or a crosslinker is added to the one-component systems (for example RTV-1). As a result of the vulcanization, the silicones or silicone rubbers achieve a solid elastic consistency, are firstly firmly bound to the matrix, secondly they exert sufficient adhesive strength on the additives.

It was surprising that, using the casing of the invention, even foods in a raw state (for example fish with dill) which require particularly gentle treatment may be furnished with such additives in a simple manner. As a result, the expensive, labor-intensive and time-consuming traditional coating is effectively replaced. In addition to raw filling, sensitive foods which must be processed or kept cold can also be furnished with the coatings desired in each case. For instance, further sectors in the food branch which were not previously accessible to such a coating method can also be opened up. Of course, using the casing of the invention, other additives such as liquid smoke and/or food dyes can also be transferred. The adhesion of the filling to the matrix and the transfer of the filling to the emulsion is further improved if the emulsion is sprayed with a thin layer of high-molecular-weight adhesive (for example collagen fibers, egg white etc.) (fixing layer).

In order to bind the silicone binder firmly to the matrix, vulcanization is required. At the same time, as a result the adhesive strength and the uptake capacity for the additive is set to the desired extent, so that the transfer of the additive to the filling can proceed without problems.

Generally, vulcanization is carried out at temperatures in the range from 10 to 250° C., preferably 80 to 200° C., and in particular 110 to 180° C., for a time period of 30 s to 120 min, preferably 30 s to 10 min, and particularly preferably from 1 to 5 min. When RTV-1 or RTV-2 silicone is used, the vulcanization can also be carried out at room temperature, if appropriate even without a catalyst; however, the reaction time increases considerably. Of the RTV-2 silicones, the addition-curing types are preferred. They expediently contain a small amount of a platinum catalyst. This catalyzes the hydrosilylation reaction which effects the curing. After the vulcanization, the binder layer is water-insoluble.

The flat or tubular food casing is coated on the side facing the filling, that is to say in the case of a tubular casing, it is situated on the inside. In a particular embodiment, the casing has a longitudinal seam.

The support material, also termed matrix, has the following advantages. It is simple to produce and can take up a sufficient amount of additives and transfer them to the filling. Such additives can also be coarse-grained or lumpy. The binder has a good adhesion to said support materials and a good adhesive strength for the additives. The matrix coated with the binder has a high elasticity and may be completely removed again from the filling, with uniform transfer of the additives being ensured. The binder is completely removed together with the matrix on taking off the casing, and is not transferred to the filling.

The casing of the invention in addition has a high microbial stability and a long storage life. In addition, it has an oxygen and water vapor permeability which can be set in a defined manner.

A coating having about 5 to 100 g/m², preferably about 10 to 60 g/m², of silicone and/or silicone rubber changes the oxygen permeability of the matrix material only slightly. The application rate depends on the type of the support. It must be of a size such that a coating as complete as possible is achieved. In the case of a support having a smooth surface, for example a film, the application rate can therefore be lower than in the case of a support having a rough surface, for example a textile material. As shown in the examples hereinafter, a plurality of binder layers which contain the same or different silicones and/or silicone rubbers can also be present.

The casing is usable not only for foods which are processed at low temperatures, but also for those which are scalded, boiled or heated in other ways in the casing. A plurality of binder layers are applied preferably directly one above the other.

As synthetic polymers for the matrix, use is made of polyolefin (PO), preferably polyethylene (PE), in particular linear low density polyethylene (LLDPE), polyamide (PA), polyester, poly(vinylidene chloride) (PVDC), poly(vinyl chloride) (PVC) and/or polystyrene. However, preferably the base material is regenerated or precipitated cellulose or, as already mentioned at the outset, a textile woven fabric or mixed woven fabric, woven fabric having an acrylate layer, plastic and composite of plastic/paper. It is also possible to proceed from a cellulose fiber skin which must first be cut open. Cellulose casings can also be reinforced, preferably with a wet-strength fiber paper, in particular a hemp fiber paper.

Casings based on synthetic polymers can be single-layer or multilayer, wherein the latter optionally have adhesion promoter layers (AP) as interlayers, for example casings having a layer sequence PA/PO/PA, PA/(PO+AP)/PA, PA/AP/PO/AP/PA or PE/AP/PA. Adhesion promoters which are usable are, inter alia, polyolefins having functional groups, such as polyethylene grafted with maleic anhydride.

The binders or binder mixtures (different silicones may also be mixed) of the adhesion layer for the additive with which the food casing is coated are silicone, silicone rubber or mixtures thereof which have a high adhesion strength and a viscosity of 10 000 to 200 000 mPas. Preference is given to a liquid silicone rubber (LSR) which is mixed from two components and is vulcanizable at about 90 to 220° C. Immediately after the components are mixed the process of vulcanization starts. Application proceeds using doctor blades or rollers, by spraying, immersion or other impregnation methods known in principle to those skilled in the art, wherein the method also depends on the desired layer thickness. Generally, they are applied to the matrix, for example using doctor blades, in the form of a paste or viscous liquid. The paste comprises pure binder or in a mixture with other substances such as minerals, salts, cellulose, diluent, for example petroleum ether, which are safe for food use. The admixtures serve, inter alia, for setting the permeability to water vapor and oxygen.

It is also possible to apply a further fixing layer onto the additive, which fixing layer likewise serves as adhesion promoter. Examples thereof are proteins or polysaccharides and polysaccharide derivatives or mixtures thereof. Suitable compounds are, in particular, cellulose derivatives, especially ethers or esters of cellulose, such as methylcellulose, but also in addition alginic acid and/or alginate, chitosan, pectin, carrageenan or starch and starch derivatives, plant and animal proteins and protein hydrolyzates having molecular weights of 5000 to 30 000 dalton, acid-boiled collagen having molecular weights of 20 000 to 1 000 000 dalton or desamidocollagen which is obtainable by alkaline hydrolysis. Particularly suitable compounds are zein, wheat protein, soy protein or pea protein and also casein, egg white, whole egg, gelatin and gelatin hydrolyzates, collagen, albumin, blood hydrolyzate, blood plasma and myoglobin. Said binders which are cold- and hot-water-soluble, insoluble or rendered insoluble are applied, in particular, onto the matrix already provided with additives. As a result, a fixing layer is obtained simultaneously. Generally, after drying, this generally has a weight of about 2 to 500 g/m².

The binder is selected according to its generally good adhesion with respect to the matrix and the additive adhering to the binder. The binder is firmly bound to the matrix and is not detachable therefrom. The additive applied thereto is, on the other hand, firmly anchored in such a manner that during finishing of the coated matrix material, no or only very little abrasion may be observed. However, during the subsequent processing, complete transfer of the additive to the filling proceeds. The casing may be removed from the filling in a problem-free manner, without components of the filling remaining adhering to it and also without even only traces of the binder being also torn off. The binders used are also distinguished in that they are completely flavor-neutral. The flavor of the filling and of the additives is not impaired.

The binder has a high elasticity and has no effect on the preexisting elasticity of the matrix.

The casing according to the invention is particularly suitable for producing cooked-meat sausage or scalded-emulsion sausage. In these cases, generally, temperatures of 75 to 90° C. (core temperature) are reached. In this temperature range, transfer of the additive occurs rapidly and without problems. In this case the silicone is unchanged, it remains inert. The fixing layer (collagen etc.), in contrast, is activated by binding to the sausage emulsion. This improves the adhesion of the additive to the sausage emulsion. The casing can also be smokable.

In a particular embodiment, the casing additionally has at least one outer coating which effectively decreases the water vapor permeability and oxygen permeability. The outer coating comprises, for example, a poly(vinylidene chloride) (PVDC) resin. Suitable compounds for a water vapor barrier layer are generally polymers which contain units of at least one of the following monomers: vinyl acetate, vinyl alcohol, ethylene, butadiene, styrene, acrylic acid and/or methacrylic acid. The coating in the case of casings provided in particular for scalded-emulsion sausage and cooked-meat sausage generally has (after drying) a weight of up to 150 g/m², preferably 30 to 120 g/m². Problems caused by delamination generally do not occur with the coated casings. They generally have a water vapor permeability of less than 150 g/m²·d, preferably less than 100 g/m²·d; depending on intended use, also less than 5 g/m²·d. In addition, the printability of the food casings can be improved by the additional coating.

The additive generally has a solid consistency and has a granular to coarse-grained, if appropriate, also lumpy, particulate structure. In addition to the customary flavorings such as pepper, coriander, curry, chilli, paprika, cinnamon, caramel or similar spices or spice mixtures, these also include garlic, onion, leek, carrots, capsicums and pepper pods, celery, asparagus and other vegetables in any possible form, mushrooms, fruits (pineapples or apple pieces, carob bean), but also fresh or dried rubbed herbs, for example parsley or dill, in particular dill tips. Grated, flaked or molten cheese or breadcrumbs are also possible as additive. In principle, as additive, use can be made of everything which improves the taste of, or refines, meat products, sausage products, fish products or cheese products.

The transferable additive can also be ground, however, with the mean particle size generally being 60 μm or more, preferably 70 μm or more. The maximum particle size can be up to 1.0 mm and more. The mean particle size is generally in the range from 60 to 800 μm, preferably from 70 to 500 μm, particularly preferably from 80 to 400 μm, very especially 90 to 250 μm. The granular additives preferably comprise particles which can be recognized with the naked eye. The particles in this case can have a spherical, elongate, flake, rod shape, or another regular or irregular shape.

The additive can be comminuted, for example after prior freeze drying, so that a uniform, relatively thin and readily adhering coating may be produced.

In addition to the abovementioned additives, food additives, in particular coloring agents, may also be transferred. Those which may be mentioned as preferred are: caramel, food dyes E124 (Cochineal Red A), E155 (Brown HT), E120 (Carmine), paprika oleoresin (E160C), concentrates and extracts of elderberry, plums or tomato, cereals (in particular barley) and preparations thereof (such as malt or malt extract), carob bean meal, guar seed meal, coffee, chicory, cocoa or dried smoke. The mean particle size of the solid food additives is generally less than 60 μm. However, liquid food additives can also be used, such as liquid smoke. In this case liquid smoke (as also with other liquid aromas) can be sprayed, if appropriate also dried, onto the silicone layer.

The amount in which the additive is applied depends very essentially on its type and the desired effect. In most cases it has proved to be sufficient to apply it in an amount of 3 to 150 g/m², preferably of 5 to 120 g/m². The total weight of the impregnation or coating is preferably 10 to 200 g/m², in particular 30 to 150 g/m². Drying after application of the additives to the matrix coated with the binder is not necessary, at least not with solid additives, which considerably simplifies the production process.

Also, after the fixing layer (“co-binder layer”) has been sprayed on, generally only little drying is required. In a particularly preferred embodiment, an aqueous composition containing 1.5 to 2% by weight of collagen fibers is sprayed on.

Transfer of the additive from the binder layer to the filling during the scalding, boiling or other heating process proceeds by the adhesion to the binder being decreased owing to the action of moisture (the process can be accelerated, that is to say activated, by heat and by the sausage emulsion fat) and the additive being released. Temperatures from 30 to about 90° C. are sufficient for this. If a fixing layer is present, then during warming or heating, this frequently binds to the surface of the filling without losing the adhesion to the additive. As a result, transfer of the additive to the food proceeds still more rapidly and more effectively.

To prevent spice particles detaching from the support during further processing, preferably, in addition, a thin layer of a film-forming protein is applied to the spice layer. Collagen fibers have proven particularly suitable therefor. The support material thus coated can subsequently be shaped to form a tube, the longitudinal edges of which are firmly bound to one another, preferably firmly stitched or glued to one another.

The thin layer of a film-forming protein situated on the spice layer at the same time prevents the spice particles from breaking out during stuffing of the tubular food casing. If the stuffed casing is subsequently heated under the action of moisture to temperatures such as are customary in the production of scalded-emulsion sausage or cooked-meat sausage (that is to say to about 80 to 90° C.), then the spice is completely transferred to the surface of the food situated therein. This applies, in particular, when the food is sausage emulsion.

Better spice adhesion during processing of the casing is achieved using the optionally present film-forming fixing layer. With suitable choice of materials (especially in the case of collagen fibers), this layer coagulates on the filling and thereby causes better binding between spice and filling (which is particularly advantageous in the case of hot transfer).

Below room temperature, transfer of the additives preferably proceeds via intimate contact of the filling, in particular under a slight pressure, with the food casing. In this case, moisture also plays a role. This transfer already takes place at temperatures below 15° C., preferably below 10° C., and in particular below 7° C. Generally, the transfer period is less than 50 hours, preferably less than 40 hours, in particular less than 30 hours. The transfer period depends on the individual case and can be determined by simple preliminary experiments. In this transfer method, binders are used which permit transfer of the additives to the filling without the action of heat. Suitable substances are, for example, silicone rubbers with correspondingly decreased adhesion strength.

In both abovementioned embodiments, an additional binder layer can be applied to the additive. Generally, this second adhesive layer comprises film-forming, high-molecular-weight, edible substances. In a preferred embodiment, the additional binder layer comprises a film-forming protein or a mixture of such proteins, particularly preferably, swollen collagen fibers. The additional layer causes a smoothing of the inner surface (easing of the stuffing process) and increases the binding of the additive to the sausage emulsion.

The invention further relates to a method of producing the casing by known methods using the abovementioned customary base materials.

The food casing can be coated or impregnated on the side facing the filling by methods which are known in principle to those skilled in the art. In a particularly simple method, the coating is applied to the matrix using a doctor blade. However, other customary embodiments can also be used. After application of the binder, the matrix thus coated is vulcanized, subsequently the additive is applied and if appropriate provided with a further fixable layer. The “adhesion process” is performed without drying, which considerably simplifies the production step.

The invention also relates to a method of producing the food casing of the invention, which method comprises the following steps:
providing a tubular or strip-shaped support material,
coating the support material with a binder which comprises a silicone, a silicone rubber or a mixture thereof, preferably using an air doctor knife or doctor roller (depending on the matrix),
vulcanizing the binder, for example at about 150° C. for about 2 minutes,
if appropriate rolling up the support material provided with a vulcanized binder layer, wherein it is expediently prevented from sticking together by an additional film rolled up with it,
applying at least one additive,
if appropriate covering the additive layer with a fixing binder, for example a layer of acid-swollen collagen fibers, and
drying the coated support material.

After drying, the binder is in this process firmly bound to the matrix, whereas the additive can be completely delivered to the filling in the context of the transfer method. If necessary, the casing is subsequently packaged and stored until use the binder-coated matrix can also be stored until further processing, that is to say coating with the additives.

The strip-shaped support material can also be shaped to form a tube having overlapping longitudinal edges, wherein the overlapping edges are fixed by a seam. Then the casing is coated on the outside, furnished with at least one additive and turned, so that the binder layer furnished with the additive is then situated on the inside of the tube.

The tubular food casing of the invention can be finished in a customary manner. For example, it can be processed to form sections closed at one end (generally tied off).

The filling is introduced into the casing thus produced. In this case it is, for example, sausage emulsion for scalded-emulsion sausage and cooked-meat sausage. Fillings which are not in pasty form, such as ham, cured product and cheese, can generally be wrapped with the coated flat material, wherein the use of a tubular casing is not excluded, however. Using the casing of the invention, these fillings may be furnished with the transferable additives. After peeling off the support material, only the additive remains on the surface of the filling, wherein the binder is not torn off in conjunction.

Use is made of the food casing of the invention, for example, in the production of cooked-meat sausage and scalded-emulsion sausage, but also for refining ham, cured product and even cheese, for example processed cheese. It is likewise suitable for transferring transferable additives to filling which must be treated particularly gently and must be processed or stored cooled, such as fish, fresh meat and uncooked preserved sausage, wherein the additives are transferred by coagulation of the proteins (in the warm state) or by moisture and pressure (in the cold state). Cold transfer functions particularly well when an adhesive fixing layer has been applied on the additive (acid-swollen collagen). With moisture, this fixing layer sticks the additive to the filling. This functions particularly well in the case of fish (for example salmon) with dill (matrix/silicone layer/dill/collagen layer/fish). The casing of the invention is also suitable in principle for wrapping baked goods and confectionery, for example for transferring grated or chopped almonds, nuts etc. In principle, the baked goods may even be baked in the film of the invention, wherein the additive is transferred at the same time.

In the examples hereinafter, percentages are to be taken to mean percentages by weight, unless stated otherwise or immediately clear from the context.

### Example 1

A polyamide film of size 50×20 cm was coated with a silicone paste (liquid silicone rubber, viscosity 120000 mPas, density 1.1 g/m³, transparent; then ELASTOSIL® EL 45554 V A+B from Wacker Chemie AG) using a doctor blade, layer thickness 25 μm, vulcanized for 10 minutes at 140° C. and subsequently multicolored pepper mixture (particle size 1 to 2 mm, amount 120 g/m²) was scattered over. Acid-swollen collagen fibers having molecular weights of 100 000 dalton and more were sprayed onto the matrix thus coated. After drying, the layer having the collagen fibers had a density of 0.5 μm. The coated matrix material was stuck together to form the tube and stuffed with ham emulsion. The ham emulsion was boiled in the casing at 78° C. (core temperature) and the casing subsequently peeled off. This resulted in a very visually attractive spice coating on the surface of the ham without parts of the filling or the spice remaining on the peeled-off casing.

### Example 2

A piece of parchment of size 30×60 cm was, as described in example 1, coated with a silicone paste (liquid silicone rubber ELASTOSIL® 45554 V A+B) in a layer thickness of 40 μl and vulcanized. Subsequently breadcrumbs were scattered on and albumen was applied to the breadcrunb layer. This fixing layer had, after drying, a thickness of 0.5 μm. The paper equipped in such a manner was stuffed with ham emulsion in molds (9×9 quadrangle and oval) and fermented (6 h, 80° C. core temperature). After cooling and peeling off, the breadcrumbs remained on the sausage emulsion and did not detach even in the case of subsequent further processing to give a sliced product. For visual improvement, the whole ham was additionally rolled in dry breadcrumbs.

### Example 3

A viscose staple woven fabric of size 15×100 cm, using a wire doctor, was first coated with an undercoat using a one-component silicone paste (liquid silicone rubber ELASTOSIL® EL 6250 F from Wacker Chemie AG) in a layer thickness of 60 μm in order to smooth the surface and decrease the consumption of adhesive silicone. Subsequently, a 40 μm thick adhesive finish of a silicone paste (liquid silicone rubber ELASTOSIL® EL 45554 V A+B) was applied and the multiple silicone layer thus produced was vulcanized for 10 minutes at 140° C. Firstly paprika granules (grain size: 3×3 mm, amount 220 g/cm²) and secondly parsley (2×0.2 mm, 130 g/m²) were scattered on one half of the surface in each case, the sample was stitched to form a tube, stuffed with ham emulsion, cooked (6 h, 80° C. core temperature) and peeled. Not only the capsicum granules but also the parsley transferred completely to the emulsion.

### Example 4

As described in example 1, a silicone paste (ELASTOSIL® 45554 V A+B) was applied to a stippled flat material made from a cellulose fiber skin viscosed on one side (caliber 60, laterally cut open and smoothed) by doctor application in a layer thickness of 25 g/m² and vulcanized (at 140° C., 5 minutes duration). Capsicum granules (3×3 mm, 220 g/m²) were scattered onto this coated flat material. Acid swollen collagen having molecular weights of 100 000 dalton and more were sprayed onto the matrix coated in this manner (0.5 μm layer thickness after drying). The material was then stitched to form a tube and stuffed with salami emulsion. After storage and ripening at 4° C. for 10 days, the spice granules had transferred completely to the filling.

That which is claimed:

1. A food casing comprising (i) a single-layer or multilayer, water-insoluble support, (ii) an adhesion layer firmly bound to the support and (iii) a transferable layer in contact with the adhesion layer comprising at least one food and/or food additive, wherein the adhesion layer comprises silicone, silicone rubber or a mixture thereof.

2. The casing as claimed in claim 1, wherein the adhesion layer comprises 5 to 80 g/m², of silicone and/or silicone rubber.

3. The casing as claimed in claim 1, wherein said casing is tubular or strip-shaped.

4. The casing as claimed in claim 1, wherein the support is a textile material, a film or a combination thereof.

5. The casing as claimed in claim 4, wherein the support comprises water-insoluble thermoplastic polymers.

6. The casing as claimed in claim 1, wherein said casing is tubular and the coating is applied on the inside.

7. The casing as claimed in claim 1, wherein the additive comprises pulverulent fine to coarse grained or lumpy foods or mixtures having a mean particle size of 60 μm or more.

8. The casing as claimed in claim 1, wherein the transferable layer comprises at least one food and at least one food additive.

9. The casing as claimed in claim 1, wherein an additional binder layer covers the food and/or food additive.

10. The casing as claimed in claim 9, wherein the additional binder layer contains a protein or protein hydrolyzate, a polysaccharide or polysaccharide derivative, or a mixture thereof.

11. The casing as claimed in claim 10, wherein the additional binder layer comprises a film-forming substance.

12. A method of producing a food casing as claimed in claim 1, said method comprising the following steps:
providing a tubular or strip-shaped support material,
coating the support material with a binder comprising silicone, a silicone rubber or a mixture thereof,
vulcanizing the binder,
applying at least one additive,
optionally covering the additive with a fixing binder and
drying the coated support material.

13. The method as claimed in claim 12, wherein the strip-shaped support material is shaped to form a tube having overlapping longitudinal edges, the binder layer provided with the additive is disposed on the inside of the tube, and the overlapping edges are fixed or glued by a seam.

14. Scalded-emulsion sausage, cooked-meat sausage, ham or cheese comprising a food casing as claimed in claim 1.

15. The casing as claimed in claim 1, wherein the adhesion layer comprises 10 to 60 g/n², of silicone and/or silicone rubber.

16. The casing as claimed in claim 5, wherein the water-insoluble thermoplastic polymers, are polyolefins, polyamides, polyesters, poly(vinylidene chloride)s and/or poly(vinyl chloride).

17. The casing as claimed claim 7, wherein the mean particle size is 7.0 to 800 μm.

18. The casing as claimed claim 7, wherein the mean particle size is 80 to 500 μm.

19. The casing as claimed claim 7, wherein the mean particle size is 90 to 400 μm.

20. The casing as claimed in claim 1, wherein the food and/or food additive comprises spices, herbs, vegetables, mushrooms, fruits, cereals, nuts and/or cheese.

21. The casing as claimed in claim 8, wherein the food additive is a coloring agent or liquid smoke.

21. The casing as claimed in claim 10, wherein the protein or protein hydrolyzate is collagen, casein, egg white or whole egg.

22. The casing as claimed in claim 10, wherein the polysaccharide or polysaccharide derivative is a cellulose ether or cellulose ester.

23. The casing as claimed in claim 10, wherein the polysaccharide or polysaccharide derivative, is methylcellulose.

24. The casing as claimed in claim 11, wherein the film-forming substance is a film-forming protein.

25. The casing as claimed in claim 11, wherein the film-forming substance comprises collagen fibers.

26. A method of transferring transferable additives to foods comprising introducing filling into a casing as claimed in claim 1 and transferring said additives by moisture and pressure for filling below room temperature or by coagulation of proteins for warm filling.
